(19) United States
(12) Patent Application Publication
(10) Pub. No.: US 2012/0194068 A1
(43) Pub. Date: Aug. 2, 2012

(54) LAMP HAVING LIGHT SENSOR

(75) Inventors: SHUN-CHUNG CHENG, TAIPEI (TW); CHIH-HUANG WANG, TAIPEI (TW); CHANG-MING CHENG, TAIPEI (TW)

(73) Assignees: LITE-ON TECHNOLOGY CORP., TAIPEI (TW); SILITEK ELECTRONIC (GUANGZHOU) CO., LTD., GUANGZHOU (CN)

(21) Appl. No.: 13/205,676

(22) Filed: Aug. 9, 2011

(30) Foreign Application Priority Data
Jan. 31, 2011 (CN) 201110035589.5

(51) Int. Cl. H01J 40/16

(52) U.S. Cl. 313/523

(57) ABSTRACT

A lamp includes a housing, a plate body disposed in the housing and having a wavelength-conversion material, a light-emitting module disposed in the housing and spaced apart from the plate body, and a light sensor disposed on the plate body. The light-emitting module includes a circuit board, and a plurality of light-emitting units disposed on the circuit board and emitting light onto the plate body. The light sensor is used for sensing the color temperature of light that is emitted from the light-emitting units and that propagates within the plate body.

### CROSS REFERENCE TO RELATED APPLICATION

This application claims priority of PROC Application No. 201110035589.5, filed on Jan. 31, 2011.

### BACKGROUND OF THE INVENTION

1. Field of the Invention

The invention relates to a lamp, and more particularly to a light-emitting diode (LED) lamp having a light sensor.

2. Description of the Related Art

Because light-emitting diodes (LED) have many advantages over some other types of lighting, such as reduced power consumption, long service life, environmental conservation, etc., they are increasingly being applied to a variety of lighting fields.

A conventional LED lamp includes LED chips coated with a phosphor powder that is excited and blended to generate light for illumination. To provide stable illumination, some LED lamps are equipped with alight sensor. The light sensor is configured to sense the color temperature or luminance of the light from the LED lamp, and to output a signal to control electric current or voltage of the LED lamp to generate illumination with stable color temperature or luminance.

However, due to the position limitation of the conventional light sensor, the conventional light sensor may not be able to accurately sense the color temperature of the LED lamp after light blending, or may obstruct light emitted from the LED lamp.

### SUMMARY OF THE INVENTION

Therefore, the object of this invention is to provide a lamp having a light sensor that can accurately sense the color temperature of the lamp after light blending.

Accordingly, a lamp according to this invention comprises a housing, a plate body disposed in the housing and having a wavelength-conversion material, a light-emitting module disposed in the housing and spaced apart from the plate body, and a light sensor disposed on the plate body. The light-emitting module includes a circuit board, and a plurality of light-emitting units disposed on the circuit board and emitting light onto the plate body. The light sensor is used for sensing the color temperature of light that is emitted from the light-emitting units and that passes through the plate body and the wavelength-conversion material.

The advantage of this invention resides in the fact that by disposing the light sensor on the plate body having the wavelength-conversion material, the light sensor can sense the color temperature of the light that passes through the wavelength-conversion material to thereby accurately obtain the color temperature of the lamp after light blending.

### BRIEF DESCRIPTION OF THE DRAWINGS

Other features and advantages of the present invention will become apparent in the following detailed description of the preferred embodiment with reference to the accompanying drawings, of which:

FIG. 1 is a schematic view of a lamp according to the preferred embodiment of the present invention;

FIG. 2 is a fragmentary enlarged sectional view of the preferred embodiment, illustrating light paths of a light-emitting module;

FIG. 3 is a fragmentary sectional top view of the preferred embodiment;

FIG. 4 is a chromaticity diagram of the preferred embodiment, illustrating the preferred embodiment using blending of white and amber lights to modulate color temperature;

FIG. 5 is a fragmentary sectional view of the preferred embodiment, illustrating how a plurality of reflective bodies can be used to change a light path of the light-emitting module;

FIG. 6 is a chromaticity diagram, illustrating how a color temperature is computed after light blending; and

FIG. 7 is a fragmentary enlarged sectional view of an alternative form of the preferred embodiment, illustrating the position of a light sensor.

### DETAILED DESCRIPTION OF THE PREFERRED EMBODIMENT

The above-mentioned and other technical contents, features, and effects of this invention will be clearly presented from the following detailed description of the preferred embodiment in coordination with the reference drawings.

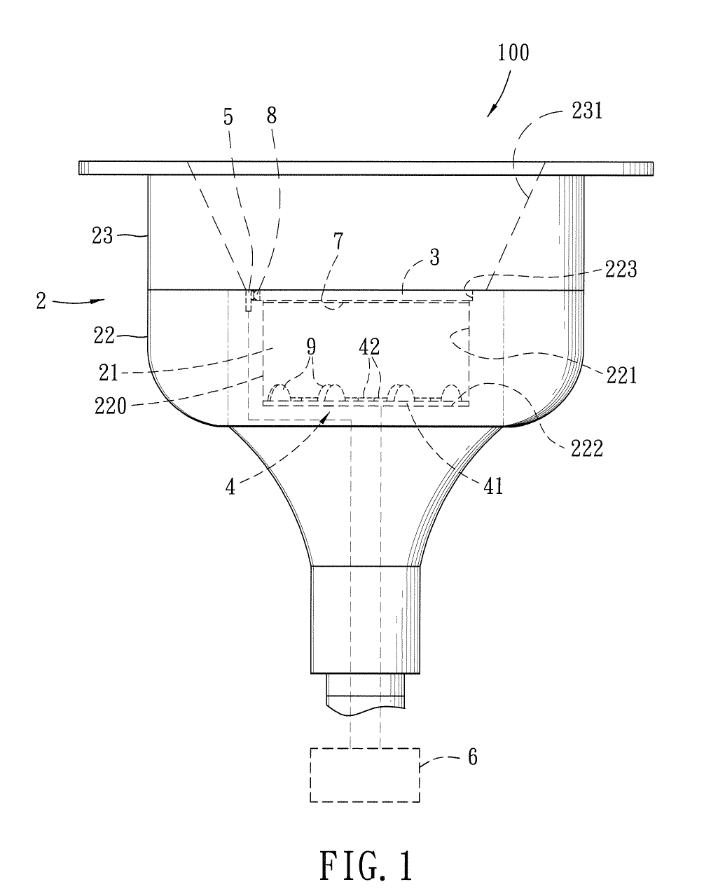

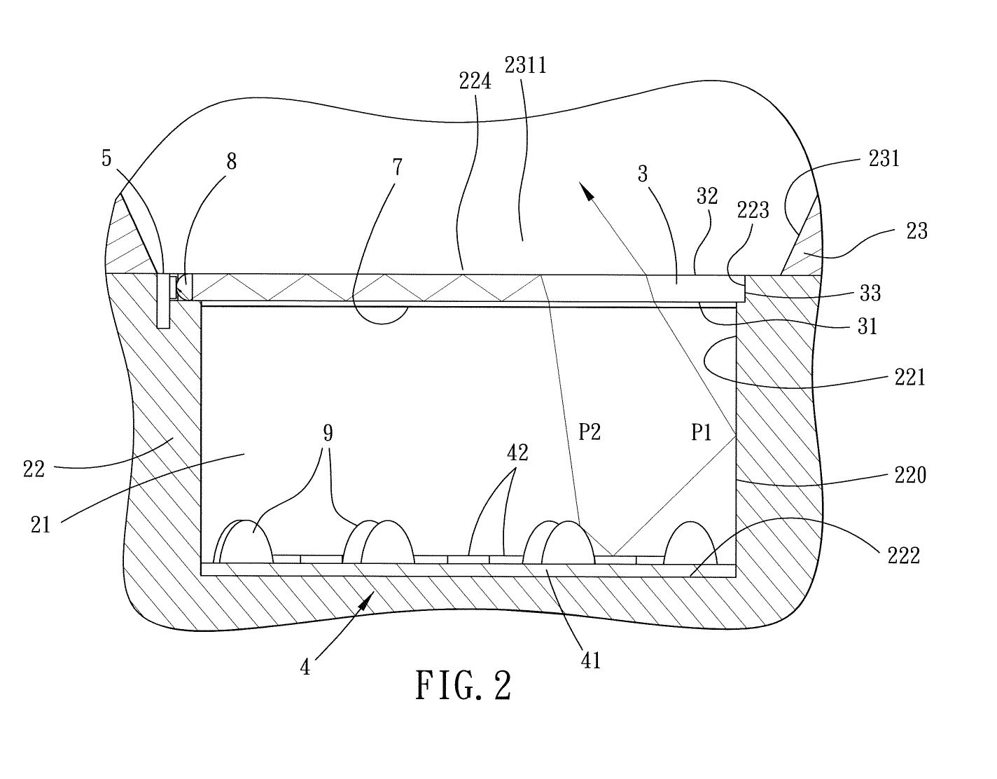

Referring to FIGS. 1 and 2, a lamp 100 according to the preferred embodiment of this invention is shown to comprise a housing 2, a plate body 3, a light-emitting module 4, a light sensor 5, and a control unit 6. The housing 2 is used for mounting of the plate body 3 and the light-emitting module 4. The light sensor 5 is disposed on the plate body 3. The control unit 6 is mounted externally of the housing 2, and is coupled electrically to the light sensor 5 and the light-emitting module 4.

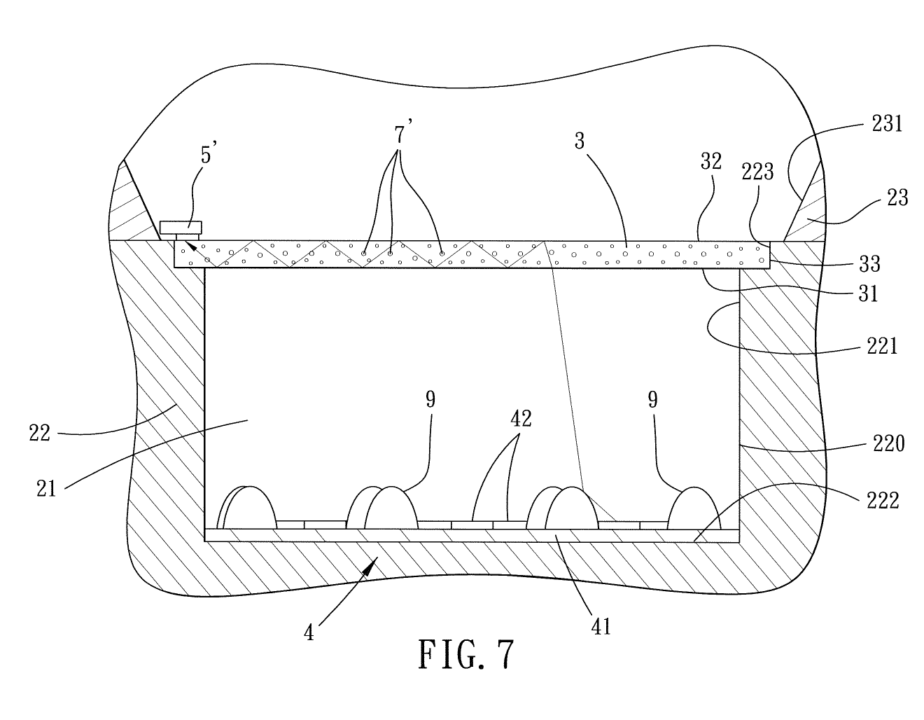

The housing 2 includes a main body portion 22, and a lampshade portion 23 disposed on the main body portion 22. The main body portion 22 includes a first surrounding wall 220, and a bottom wall 222 connected to and cooperating with the first surrounding wall 220 to define an accommodation space 21. The accommodation space 21 has a top light exit opening 224 for communicating the accommodation space 21 with an external portion of the housing 2. The first surrounding wall 220 has an inner reflective surface 221 for reflecting light. Alternatively, the accommodation space 21 may be defined by an integrally formed one-piece main body portion 22, or the main body portion 22 may include a bottom plate (not shown) and an inner surrounding plate (not shown) cooperatively defining the accommodation space 21. The first surrounding wall 220 surrounds the light exit opening 224 of the accommodation space 21 oppositely of the bottom wall 222, and further has an annular limiting groove 223 formed around a top end of the inner reflective surface 221 and extending around the light exit opening 224 of the accommodation space 21. On one side of the main body portion 22 that is opposite to the accommodation space 21, a conductive connector (not shown) is provided for connection with an external power supply (not shown). The lampshade portion 23 is annular, and has a second surrounding wall 231 defining a light-emitting hole 2311 that communicates with the light exit opening 224. The second surrounding wall 231 has an inner reflective surface for reflecting light. The reflective surface may be a surface of a reflective plate that is disposed on the second surrounding wall 231, or the lampshade portion 23 itself is made of a material that is capable of reflecting light so that the second surrounding wall 231 is reflective. The plate body 3 is mounted on the annular limiting groove 223 of the main body portion 22 of the housing 2, is exposed via the light-emitting hole 2311, and is greater than the light exit opening 224 of the accommodation space 21 so that it extends across the light exit opening 224 to cover and close the accommodation space 21. The plate body 3 is made of a transparent light guiding material, and has a dimension larger than that of the bottom wall 222. In an alternative embodiment, the lampshade portion 23 may be disposed on the plate body 3, and the surrounding wall 231 thereof defines a light-emitting hole having an area similar to that of the bottom wall 222. When light passes through the plate body 3, a portion of the light can pass through the plate body 3, while the other portion of the light can continuously generate total reflection in an interface between the plate body 3 and air, and then propagate within and along the plate body 3. The overall thickness of the plate body 3 that ranges from 1.5 mm to 3 mm can obtain a better light-emitting effect. The plate body 3 has a first side 31 facing the accommodation space 21, a second side 32 opposite to the first side 31, and a lateral side 33 interconnecting the first and second sides 31, 32. The lateral side 33 of the plate body 3 extends into the annular limiting groove 223. The plate body 3 further has a wavelength-conversion material 7. In this embodiment, the wavelength-conversion material 7 includes a phosphor powder coated on a surface of the first side 31 of the plate body 3. The wavelength-conversion material 7 is uniformly coated on the surface of the first side 31 of the plate body 3 to obtain a better light-emitting effect and to avoid generation of light halo. In another embodiment, the wavelength-conversion material 7 is mixed with the material of the plate body 3 in an injection molding process. That is, the wavelength-conversion material 7 is dispersed within the plate body 3 (as shown in FIG. 7).

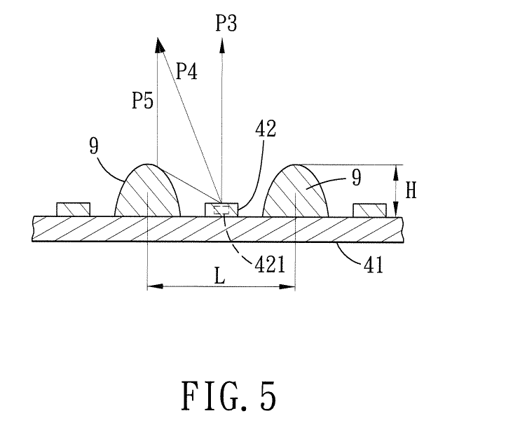

The light-emitting module 4 is disposed on the bottom wall 222 within the accommodation space 21, and is spaced apart from and faces the first side 31 of the plate body 3. The light-emitting module 4 includes a circuit board 41 mounted on the bottom wall 222, and a plurality of light-emitting units 42 disposed on the circuit board 41 and emitting light onto the plate body 3. Further, the lamp 100 further includes a plurality of reflective bodies 9 mounted on the circuit board 41 and same side as the light-emitting units 42. Each light-emitting unit 42 is configured as a light-emitting diode (LED) package that includes at least one LED chip 421 (see FIG. 5). Since the wavelength-conversion material 7 is mounted on the plate body 3 and is spaced apart from the light-emitting units 42, the wavelength-conversion material 7 can be prevented from deterioration caused by a high temperature due to direct contact with the light-emitting units 42. That is, the wavelength-conversion material 7 of this embodiment utilizes a technique of remote phosphor.

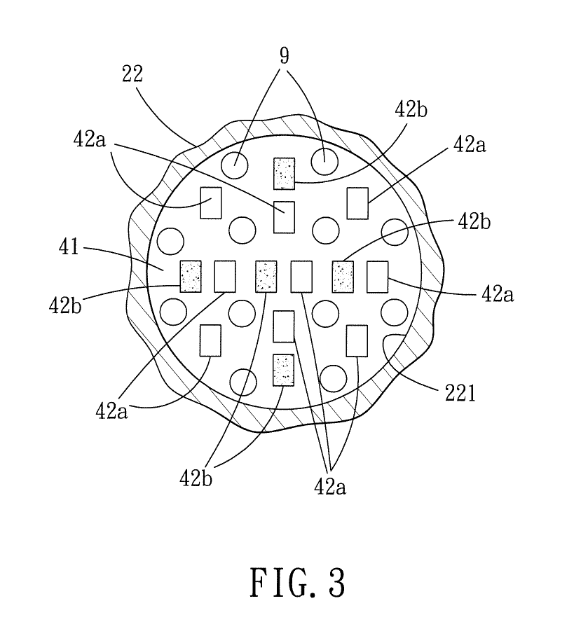

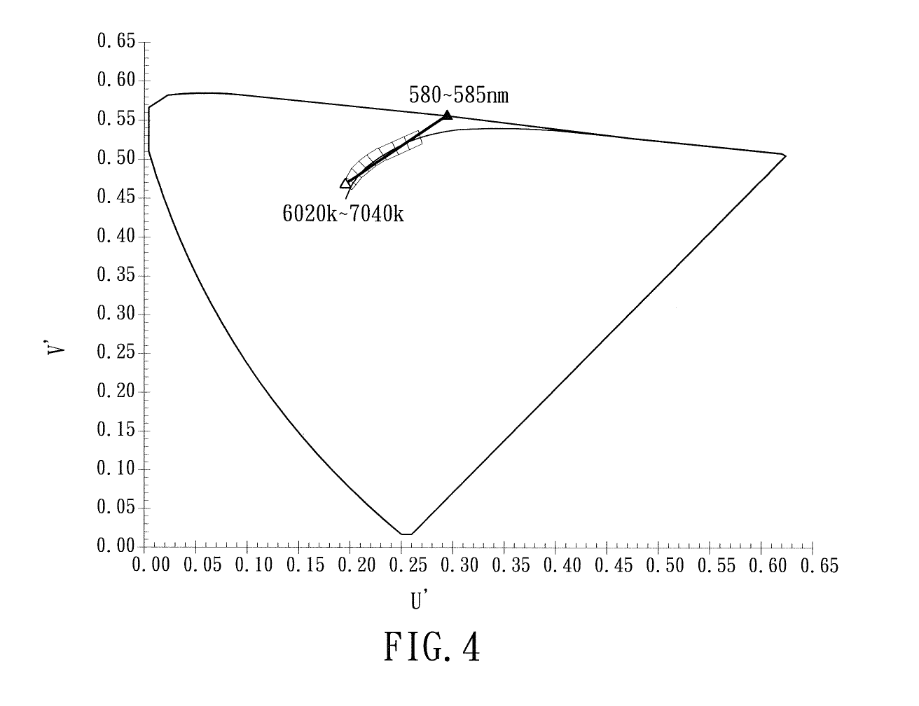

With reference to FIGS. 3 and 4, the light-emitting units or LED packages 42 include a plurality of blue LED packages (42a) and a plurality of amber LED packages (42b). The layout of the light-emitting units 42 on the circuit board 41 has a crisscross arrangement. In particular, the blue LED packages (42a) and the amber LED packages (42b) are disposed alternately along two crossing lines. Four additional light-emitting units 42, preferably blue LED packages (42a), are disposed respectively in quadrants defined by the two crossing lines. The reflective bodies 9 are disposed in each quadrant around one of the four light-emitting units 42. In this embodiment, the reflective bodies 9 in each quadrant surround one of the blue LED packages (42a). In an alternative embodiment, the layout of the light-emitting units 42 on the circuit board 41 may have a radial arrangement, and the blue LED packages (42a) and the amber LED packages (42b) may be disposed alternately in the radial direction. Each amber LED package (42b) emits light with a wavelength of 580 nm to 585 nm. Each blue LED package (42a) emits light that passes through the wavelength-conversion material 7 (for example, containing yellow phosphor) to produce white light having a color temperature that ranges between 6020K and 7040K. Light emitted by each amber LED package (42b) will not have any color change after passing through the wavelength-conversion material 7, but will only weaken in strength. The color temperature of light from blending of white and amber lights according to different weight proportions may include several color temperature ranges commonly used in the illumination field. Each blue LED package (42a) is provided with a blue light-emitting chip to emit blue light. Each amber LED package (42b) is provided with an amber light-emitting chip to emit amber light. Alternatively, each of the blue and amber LED packages (42a, 42b) may be provided with a plurality of light-emitting chips (not shown). Further alternative is that each blue LED package (42a) and each amber LED package (42b) may respectively be coated with a phosphor powder (not shown) so that the LED chip(s) inside each blue LED package (42a) and each amber LED package (42b) may emit blue light and amber light, respectively, after exciting the phosphor powder.

With reference to FIGS. 2 and 3, the light sensor 5 in this embodiment is disposed on the lateral side 33 of the plate body 3. Based on the aforesaid description, since a portion of light propagates within the plate body 3, the white light generated through the wavelength-conversion material 7 by the blue LED package (42a) and the amber light emitted by the amber LED package (42b) will continuously generate total reflection within the plate body 3 and produce a blended light. The blended light is then transmitted to the light sensor 5, so that the light sensor 5 can receive the blended light and sense the color temperature of the blended light accordingly. In other words, one portion of light emitted by the light-emitting units 42 is reflected through the first surrounding wall 220 or the reflective bodies 9 and another portion of light emitting from the light-emitting units 42 is directly radiated toward the plate body 3 and passes through the wavelength-conversion material 7. A large portion of the light passes through the plate body 3 [see the light path (P1) in FIG. 2], while a small portion of the light remains in the plate body 3 to generate total reflection that is transmitted to the lateral side 33 of the plate body 3 for emission [see the light path (P2)]. The light emitted from the lateral side 33 of the plate body 3 is sensed by the light sensor 5. Since only the light from the blue LED package (42a) can excite the wavelength-conversion material 7 when passing through the same to become white light, and since the light from the amber LED package (42b) retains the amber color after passing through the wavelength-conversion material 7, the white light and the amber light can propagate and blend uniformly within the plate body 3. Hence, the light sensor 5 can sense the color temperature of the blended white and amber lights.

With reference to FIG. 5, each reflective body 9 extends upwardly from the circuit board 41, and has a rounded shape, and reflects light emitted from the surrounding light-emitting units 42 to the plate body 3. The rounded shape is selected from the group consisting of a semi-spherical, parabolic, or semi-elliptical shape. In general, the light-emitting chip 421 has a characteristic in that its luminous intensity decreases from the center to the sides. For example, as shown in FIG. 5, the luminance of a light path (P3) is 1 lumen, whereas the luminance of a light path (P4) is reduced to 0.7 lumen. When light is emitted from each light-emitting unit 42, distribution of light during emission is not uniform, and bright spots are formed. Through the effect of the reflective bodies 9, the light paths on the sides of each light-emitting unit 42 can be altered, thereby reducing the phenomenon of non-uniformity distribution of light during emission. For example, as shown in FIG. 5, a reflected light path (P5) having a luminance of 0.3 lumen is combined with the light path (P4) having the luminance of 0.7 lumen to obtain a resultant luminance output that is equal to that of the light path (P3) which is 1 lumen. In this way, the distribution of light during emission is more uniform. Preferably, the height of each reflective body 9 is directly proportional to the distance between each two adjacent ones of the reflective bodies 9, and is inversely proportional to the full width at half maximum (FWHM) of each light-emitting chip 421. More preferably, the height (H) of each reflective body 9 and a distance (L) between each two adjacent ones of the reflective bodies 9 conform to below formula:

$$H = \frac{L}{2} \times tan ( 90 - θ ) where θ = \frac{1}{2} FWHM$$

where L is a distance from the center of one of the reflective bodies 9 to the center of an adjacent one of the reflective bodies 9, H is the height of each reflective body 9, and FWHM is the full width at half maximum of the light-emitting chip 421.

In this embodiment, the lamp 100 further comprises a light-collecting lens 8 disposed between the plate body 3 and the light sensor 5. The light-collecting lens 8 is a convex lens that projects from the lateral side 33 of the plate body 3 for collecting the light propagated from the lateral side 33 of the plate body 3 to thereby increase the number of lumens of light received by the light sensor 5, thereby enhancing the accuracy of the light sensor 5. In the aforesaid embodiment, the light-emitting units 42 have two different types of LED packages (42a, 42b), the light sensor 5 is used to receive lights respectively emitted by the two different types of LED packages (42a, 42b) and pass through the wavelength-conversion material 7 and sense the color temperature of its blended light. In an alternative embodiment, the light-emitting unit 42 may only have a single type of LED package (not shown), and in this case, the light sensor 5 is used to sense the color temperature of light emitted by the LED package and that passes through the wavelength-conversion material 7.

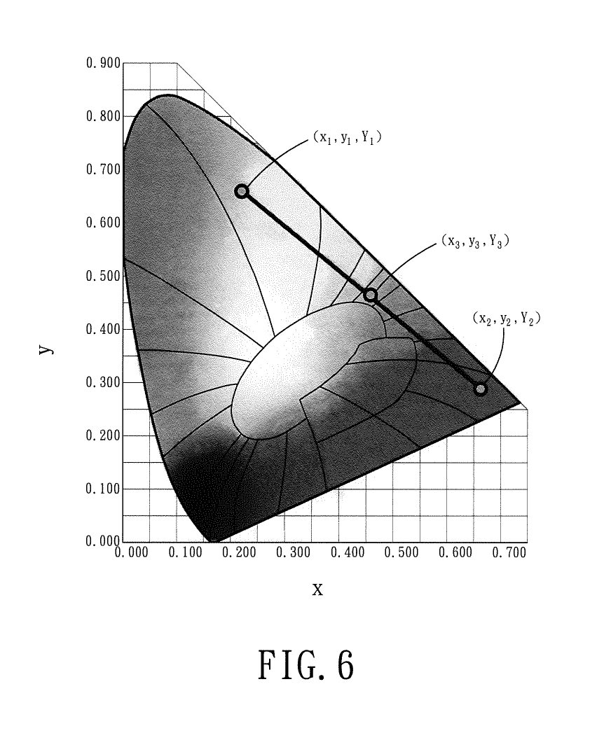

Referring again to FIGS. 1 and 6, the control unit 6 is coupled electrically to the light sensor 5, and receives signals about the color temperature data transmitted from the light sensor 5 for adjusting the color temperature of the lamp 100 accordingly. By adjusting the luminance weight proportion of the light from the blue and amber LED packages (42a, 42b), the control unit 6 can change the color temperature of the blended white and amber lights to reach a target value. In this manner, the color temperature of the lamp 100 can be modulated. The control unit 6 calculates the color temperature value of a blended light through a formula. The method for calculating the color temperature of the blended light is explained hereinafter with reference to FIG. 6. Assuming that the two lights for light blending are respectively represented by (x₁,y₁,Y₁) and (x₂,y₂,Y₂), where (x₁,y₁) and (x₂,y₂) are color coordinates of the respective two lights, and (Y₁) and (Y₂) are luminance of the respective two lights, the color coordinates of the blended light is

$$( {x}_{3} , {y}_{3} ) = ( \frac{{m}_{1} {x}_{1} + {m}_{2} {x}_{2}}{{m}_{1} + {m}_{2}} , \frac{{m}_{1} {y}_{1} + {m}_{2} {y}_{2}}{{m}_{1} + {m}_{2}} )$$

$$where$$

$${m}_{1} = \frac{{Y}_{1}}{{y}_{1}} and {m}_{2} = \frac{{Y}_{2}}{{y}_{2 }}$$

The luminance after blending is

Y₃=Y₁+Y₂

Through the aforesaid formula, the control unit 6 can calculate the color temperature of the blended light and can adjust the color temperature of the lamp 100 to the target value.

FIG. 7 illustrates an alternative form of the preferred embodiment. In this embodiment, the light sensor 5′ is disposed at one end of a surface of the second side 32 of the plate body 3, and the wavelength-conversion material 7′ is dispersed within the plate body 3. In this embodiment, lights emitted by the light-emitting units 42 can simultaneously pass through the wavelength-conversion material 7′ and the plate body 3, and a portion of the light can similarly propagate within the plate body 3 and blend light as described above. That is, the light from the blue LED packages (42a) (see FIG. 3) can react with the wavelength-conversion material 7′ to become white light, and the light of the amber LED packages (42b) (see FIG. 3) has no reaction with the wavelength-conversion material 7′ so that it remains amber light. The white light and the amber light are blended in the plate body 3 to become a blended light that is transmitted to the light sensor 5′. The light sensor 5′ receives and senses the color temperature of the blended light. Furthermore, the sizes or the relative dispositions of the plate body 3, the main body portion 22, and the light sensor 5′ can be suitably adjusted so that the light sensor 5′ will not block any emitted light and so that the overall light emitting effect will not reduce. In this embodiment, the plate body 3 is disposed on the annular limiting groove 223, and thus has a size larger than a light-emitting region of the light-emitting module 4 which is disposed in the accommodation space 21, and the light sensor 5′ is disposed at one end of the second side 32 of the plate body 3 in proximity to the lateral side 33 outside of the annular limiting groove 223 so that it will not block the light emission of the lamp 100. Alternatively, the light sensor 5′ may be disposed at one end of the first side 31 of the plate body 3 within the annular limiting groove 223 inside the main body portion 22 so that the blended light may be transmitted to the light sensor 5′.

In summary, the lamp (100) of the present invention, by disposing the light sensor 5, 5′ on the plate body 3, can accurately sense the color temperature of the light emitted by the light-emitting units 42 after exciting the wavelength-conversion material 7, 7′. Further, because the technique of remote phosphor is applied to the wavelength-conversion material 7, 7′, the latter is prevented from deterioration caused by a high temperature due to direct contact with the light-emitting units 42. Moreover, with incorporation of the structural design of the light-collecting lens 8, the accuracy of the light sensor 5 can be enhanced. Additionally, through the provision of the light-reflecting bodies 9, the emission of light of the present invention is more uniform. Furthermore, the present invention uses the white light and the amber light for light blending, and can modulate various color temperature effects commonly used in the illumination field. Hence, the purpose of the present invention is realized.

While the present invention has been described in connection with what is considered the most practical and preferred embodiment, it is understood that this invention is not limited to the disclosed embodiment but is intended to cover various arrangements included within the spirit and scope of the broadest interpretation so as to encompass all such modifications and equivalent arrangements.

What is claimed is:

1. A lamp comprising:
a housing;
a plate body disposed in said housing and having a wavelength-conversion material;
a light-emitting module disposed in said housing and spaced apart from said plate body, and including a circuit board, and a plurality of light-emitting units disposed on said circuit board and emitting light onto said plate body; and
a light sensor disposed on said plate body for sensing light that is emitted from said light-emitting units and that propagates within said plate body.

2. The lamp as claimed in claim 1, wherein said light sensor is disposed on a lateral side of said plate body.

3. The lamp as claimed in claim 1, wherein said wavelength-conversion material includes a phosphor powder coated on a surface of said plate body that faces said light-emitting module.

4. The lamp as claimed in claim 1, wherein said wavelength-conversion material includes a phosphor powder dispersed in said plate body.

5. The lamp as claimed in claim 1, further comprising a light-collecting lens disposed between said plate body and said light sensor.

6. The lamp as claimed in claim 1, further comprising a plurality of reflective bodies each disposed on said circuit board between at least two light-emitting units.

7. The lamp as claimed in claim 6, wherein each of said light-emitting units is configured as a light-emitting diode (LED) package that includes at least one light-emitting chip, the height of each of said reflective bodies being directly proportional to the distance between each two adjacent ones of said reflective bodies, and being inversely proportional to the full width at half maximum (FWHM) of said light-emitting chips.

8. The lamp as claimed in claim 6, wherein a distance between each two adjacent ones of said reflective bodies and the height of each of said reflective bodies conform to below formula:
$$H = \frac{L}{2} \times tan ( 90 - θ ) , where θ = \frac{1}{2} FWHM ,$$
where L is a distance from the center of one of said reflective bodies to the center of an adjacent one of said reflective bodies, H is the height of each of said reflective bodies, and FWHM is the full width at half maximum of a light-emitting chip of one of said light-emitting units between each two adjacent ones of said reflective bodies.

9. The lamp as claimed in claim 6, wherein each of said reflective bodies has a rounded shape, and reflects light emitted from said light-emitting units to said plate body.

10. The lamp as claimed in claim 9, wherein said rounded shape is selected from the group consisting of a semi-spherical, parabolic, or semi-elliptical shape.

11. The lamp as claimed in claim 1, wherein each of said light-emitting units is configured as a light-emitting diode (LED) package, said LED packages of said light-emitting units including a plurality of blue LED packages and a plurality of amber LED packages.

12. The lamp as claimed in claim 1, said light sensor is disposed at one end of a surface of said plate body that is opposite to said light-emitting module.

13. The lamp as claimed in claim 1, further comprising a control unit coupled electrically to said light sensor and said light-emitting units, said control unit receiving the color temperature transmitted from said light sensor for adjusting the color temperature of said light-emitting units.

14. The lamp as claimed in claim 1, wherein the housing further comprising an annular limiting groove for mounting said plate body.

15. A lamp comprising:
a housing;
a plate body disposed in said housing, said plate body and said housing defining an accommodation space;
a light-emitting module located in said accommodation space and spaced apart from said plate body, said light-emitting module emitting light onto said plate body; and
a light sensor disposed on a region of said plate body for receiving light that is emitted from said light-emitting module and that propagates within said plate body.

16. The lamp as claimed in claim 15, wherein said plate body has a first side facing said light-emitting module, a second side opposite to said first side, and a lateral side interconnecting said first and second sides, said region of said plate body being a region on said lateral side or a region on one of said first and second sides adjacent to said lateral side.

17. The lamp as claimed in claim 15, wherein said plate body has a wavelength-conversion material.

18. The lamp as claimed in claim 15, wherein said accommodation space has a light exit opening, said plate body extending across said light exit opening, said plate body being greater than said light exit opening.

19. The lamp as claimed in claim 18, wherein said housing includes a bottom wall and a surrounding wall which cooperatively define said accommodation space, said surrounding wall surrounding said light exit opening oppositely of said bottom wall and having an annular limiting groove extending around said light exit opening, said lateral side of said plate body extending into said annular limiting groove.
